(19) United States
(12) Patent Application Publication
(10) Pub. No.: US 2014/0133840 A1
(43) Pub. Date: May 15, 2014

(54) METHOD WHICH USES MULTI-MEDIA TO CONFIGURE A MULTI-MEDIA CAPTURING DEVICE

(71) Applicants: ZHONG BAO, Guangdong (CN); Sheng Wei Ren, Guangdong (CN); Zheng Ji Tao, Guangdong (CN)

(72) Inventors: ZHONG BAO, Guangdong (CN); Sheng Wei Ren, Guangdong (CN); Zheng Ji Tao, Guangdong (CN)

(21) Appl. No.: 13/674,897

(22) Filed: Nov. 12, 2012

(51) Int. Cl. H04N 5/917

(52) U.S. Cl. CPC H04N 5/917
USPC 386/328

(57) ABSTRACT

The invention relates to customization of multi-media capturing devices and more particularly a method which uses multi-media to configure a multi-media capturing device. First, running a software application installed in a configuring device to encode configuration information to a configuring image or video or audio in the configuring device on the basis of user input or by automatic detection of the software application or by obtaining information automatically detected by the configured device; outputting to the configured device; finally the configured device decoding the configured image or video or audio and undergoing automatic configuration according to the configuration information. The invention does not require the configured device and the configuring device to have other specialized communication interface devices. It makes use of the indispensable image or audio input-output devices in the two devices to transmit configuration information, thus reducing number of components and production costs of the configured device.

### BACKGROUND OF THE INVENTION

The present invention relates to customization of multi-media capturing devices and more particularly pertains to a method which uses multi-media to configure a multi-media capturing device.

Multi-media capturing devices such as video cameras, cameras, camera phones, computers with audio or image capturing functions and any other electronic devices with audio or image capturing functions are commonly referred as configured devices. Many electronic devices need to be set up and adjusted according to the user's environment. For instance, when using a wireless network video camera, a user needs to add the video camera into his wireless area network; when using a particular software in a computer, a user is required to enter user name, passwords, preferences and so forth. To complete the above tasks, at present a human-machine interface is provided by the configured device, and the user makes use of input tools such as keyboard or computer mouse to set up the device. This method is convenient for use in mobile phones, computers, and other electronic devices which have display functions and input tools. However, for devices such as monitoring network video cameras which do not provide display functions or input tools, they have to rely on other tools such as monitors, keyboards, mobile phones, personal digital assistants (PDA), tablet PCs, notebooks or computers and other similar devices which provide display functions and input tools in order to start the set-up. These auxiliary devices used to configure the configured devices are known as configuring devices.

To configure a device which needs configuration by another device, there must be some kind of connection between the two devices. The connection can be wired connection such as USB, serial data cable, network cable and so forth, or it can be wireless connection such as WIFI, RF, Bluetooth, NFC (Near Field Connection) and so forth.

Wired connection is very reliable, but both devices must be disposed with corresponding interfaces and a suitable connection wire is also needed. Configuration cannot be carried out if there is no corresponding interface on the configuring devices. For example, a configured device with a USB device port cannot be configured by a mobile phone which does not have a corresponding USB host port.

Wireless connection such as RF, Bluetooth or NFC also requires the two devices to have the same functional modules; at the same time, they must communicate by the same communication protocol, or else information cannot be transmitted. The configured device needs to get access to the current wireless area network first before it undergoes the configuration process using WIFI. This is not applicable to those devices which do not have WIFI device.

In addition, the biggest flaw of the prior art is the interfaces used for configuration on the configured device. No matter it is a wired interface or a wireless interface, the interface will become redundant once the configuration is completed. For example, if a USB interface is used to configure a network video camera, the user no longer needs to use the USB interface provided by the video camera once the configuration is completed. Another example is using a wired network interface to configure a wireless network device. Although the wired network interface can still be used after configuration, most of the users will opt for wireless connection as otherwise the device would not be functioning at its best; as such, the wired interface becomes redundant.

### BRIEF SUMMARY OF THE INVENTION

The present invention provides a method which uses multi-media to configure a multi-media capturing device to overcome the shortcomings of the above mentioned prior art. It can solve the problems of inconvenient and inefficient connection between a configuring device and a configured device.

To attain this, the present invention provides a method which uses multi-media to configure a multi-media capturing device comprising: firstly, running a software application installed in a configuring device to generate a configuring image, audio or video in the configuring device by means of one of the following: (1) the software application generating the configuring image, audio or video accordingly to configuration information input from a user; or (2) the software application detecting configuration information being environmental parameters of the configured device by means of a functional module of the configuring device and displaying the configuration information in the configuring device, and then automatically encoding and embedding the configuration information to the configuring image, audio or video after selecting and inputting of the configuration information; or (3) the software application generating a first image, audio or video; the configured device capturing the first image, audio or video, comparing the first image, audio or video with a second image, audio or video pre-set in the configured device; and in case the first image, audio or video matches the second image, audio or video the configured device entering a configuration mode, searching automatically for configuration information being environmental parameters of the configured device, encoding and embedding the configuration information to a third image, audio or video and then playing the third image, audio or video; the configuring device obtaining the configuration information by decoding the third image, audio or video played by the configured device and displaying the configuration information for selection and input by user; the software application automatically encoding and embedding the configuration information to the configuring image, audio or video after the selection and input of the configuration information; secondly, the software application playing the configuring image, audio or video in the configuring device, followed by the configured device recording the configuring image, audio or video by a shooting module or audio input module thereof, and then obtaining the configuration information by decoding the configuring image, audio or video and thereafter configuring the configured device according to the configuration information.

The configured device sending feedback information which reflects various status of the configured device during configuration process to the configuring device through a speaker, an audio output interface or an LED status indicating light; the configuring device in response to the feedback information either informing the user or automatically and dynamically adjusting the configuration information to optimize configuration of the configured device.

The configured device sending feedback information which reflects various status of the configured device during configuration process to the configuring device through a speaker, an audio output interface or an LED status indicating light; the configuring device in response to the feedback information adjusting the configuration information and thereafter sending the adjusted configuration information to the configured device.

The configuration information refers to WIFI access point information, Bluetooth access point information, ambient temperature, ambient brightness, volume level, user name and password or other data needed to input to the configured device in order to complete the configuration.

The configured device is wireless network video camera, smart phone, tablet PC or any other electronic device with image or audio input function.

The configuring device is mobile phone, personal digital assistant, tablet PC, notebook computer or desktop computer.

The present invention does not require the configured device and the configuring device to have other specialized communication interface devices. It makes use of the indispensable image or audio input-output devices already provided in the two devices to transmit the configuration information, thus reducing the number of components of the configured device and lowering the production costs of the configured device. The media used for transmitting information between the configured device and the configuring device is ordinary light and audio. Therefore, the connection established between the configured device and the configuring device is simpler and more reliable than other existing methods and communication will not disallowed due to the lack of common communication protocol. The configuration information not only can be saved in plain text using a generic or an encryption method, but it can also be saved in form of static image, moving image, or audio since the configuration information has been encoded and embedded into images or audio. Configuration information saved in form of static image, moving image, or audio cannot be easily identified by other people, therefore providing a certain degree of confidentiality.

### DETAILED DESCRIPTION OF THE INVENTION

### Embodiment 1

A method which uses multi-media to configure a multi-media capturing device which comprises firstly, running a software application installed in a configuring device to generate a configuring image, audio or video in the configuring device by means of one of the following: (1) the software application generating the configuring image, audio or video accordingly to configuration information input from a user; or (2) the software application detecting configuration information being environmental parameters of the configured device by means of a functional module of the configuring device and displaying the configuration information in the configuring device, and then automatically encoding and embedding the configuration information to the configuring image, audio or video after selecting and inputting of the configuration information; or (3) the software application generating a first image, audio or video; the configured device capturing the first image, audio or video, comparing the first image, audio or video with a second image, audio or video pre-set in the configured device; and in case the first image, audio or video matches the second image, audio or video the configured device entering a configuration mode, searching automatically for configuration information being environmental parameters of the configured device, encoding and embedding the configuration information to a third image, audio or video and then playing the third image, audio or video; the configuring device obtaining the configuration information by decoding the third image, audio or video played by the configured device and displaying the configuration information for selection and input by user; the software application automatically encoding and embedding the configuration information to the configuring image, audio or video after the selection and input of the configuration information; secondly, the software application playing the configuring image, audio or video in the configuring device, followed by the configured device recording the configuring image, audio or video by a shooting module or audio input module thereof, and then obtaining the configuration information by decoding the configuring image, audio or video and thereafter configuring the configured device according to the configuration information.

Depending on actual circumstances, the configured device sending feedback information which reflects various status of the configured device during configuration process to the configuring device through a speaker, an audio output interface or an LED status indicating light; the configuring device in response to the feedback information either informing the user or automatically and dynamically adjusting the configuration information to optimize configuration of the configured device.

Depending on actual circumstances, the configured device sending feedback information which reflects various status of the configured device during configuration process to the configuring device through a speaker, an audio output interface or an LED status indicating light; the configuring device in response to the feedback information adjusting the configuration information and thereafter sending the adjusted configuration information to the configured device.

Depending on actual circumstances, the configuration information refers to WIFI access point information, Bluetooth access point information, ambient temperature, ambient brightness, volume level, user name and password or other data needed to input to the configured device in order to complete the configuration.

Depending on actual circumstances, the configured device is wireless network video camera, smart phone or tablet PC. The configuring device is mobile phone, personal digital assistant, tablet PC, notebook computer or desktop computer.

### Embodiment 2

A method which uses an static image generated by a mobile phone to configure a WIFI module of a wireless network video camera with no audio input function which comprises: A user firstly runs a software application installed in the mobile phone; the software application detects configuration information being WIFI access points nearby the mobile phone by means of a WIFI module of the mobile phone and displays the configuration information being WIFI access points nearby in the display screen of the mobile phone; the user then selects the desired WIFI access point in the mobile phone and inputs other necessary information such as access password; the software application then automatically encodes and embeds the configuration information to a configuring image such as a two-dimensional code after inputting of the configuration information; the mobile phone plays the configuring image on the display screen thereof; the user positions the display screen of the mobile phone in front of the lens of the video camera; the video camera records the configuring image and then obtains the configuration information by decoding the configuring image and thereafter automatically configures the WIFI module of the video camera, so that the wireless network video camera could be connected to the desired wireless network. The video camera may send feedback information which reflects various status of the video camera during configuration process to the mobile phone and the user through an LED status indicating light integrally formed on the video camera; the mobile phone records the feedback information of the LED status indicating light by means of its camera, and decodes the feedback information to understand the status of the video camera, and if necessary in response to the feedback information either informs the user or automatically and dynamically adjusts the configuration information to optimize configuration of the video camera.

### Embodiment 3

A method which uses a moving image generated by a mobile phone to configure a WIFI module of a wireless network video camera with audio output function which comprises: A user firstly runs a software application installed in the mobile phone; the software application detects configuration information being WIFI access points nearby the mobile phone by means of a WIFI module of the mobile phone and displays the configuration information being WIFI access points nearby in the display screen of the mobile phone; the user then selects the desired WIFI access point in the mobile phone and inputs other necessary information such as access password; the software application then automatically encodes and embeds the configuration information to a set of configuring images or to the transformation process of a set of configuring images after inputting of the configuration information; the mobile phone plays the set of configuring images in a predetermined manner on the display screen thereof; the user positions the display screen of the mobile phone in front of the lens of the video camera; the video camera records the set of configuring images by means of its moving images shooting function and then obtains the configuration information by decoding the set of configuring images and thereafter automatically configures the WIFI module of the video camera. The video camera may send feedback information to the mobile phone and the user through an audio output interface or speaker integrally formed on the video camera; the mobile phone records the feedback information which reflects various status of the video camera during configuration process by means of its audio input interface to understand the status of the video camera, and if necessary in response to the feedback information either informs the user or automatically and dynamically adjusts the configuration information to optimize configuration of the video camera.

### Embodiment 4

A method which uses an audio generated by a tablet PC to configure a WIFI module of a wireless network video camera with no audio input function which comprises: A user firstly runs a software application installed in the mobile phone; the software application detects configuration information being WIFI access points nearby the tablet PC by means of a WIFI module of the tablet PC and displays the configuration information being WIFI access points nearby in the display screen of the mobile phone; the user then selects the desired WIFI access point in the tablet PC and inputs other necessary information such as access password; the software application then automatically encodes and embeds the configuration information to a configuring audio after inputting of the configuration information, wherein the configuration audio may be an audio which is encoded according to a specific rule and could only be recognized by the configured video camera, or an audio with specific meaning or pleasing melody which is recognizable by people, such as a music melody, a conversation or even bird whistling sound; the tablet PC plays the configuring audio by its audio output component such as its earphone interface, its internal speaker or its audio interface; the video camera records the configuring audio by means of its own audio input function and then obtains the configuration information by decoding the configuring audio and thereafter automatically configures the WIFI module of the video camera. The video camera may by means of its speaker encode and embed to an audio containing feedback information which reflects various status of the video camera during configuration process, and sends the audio containing feedback information to the tablet PC and the user through its speaker or audio output interface; the tablet PC records the audio containing feedback information by means of its audio input component, and decodes the feedback information to understand the status of the video camera, and if necessary adjusts the configuration information and thereafter sends the adjusted configuration information to the video camera.

### Embodiment 5

A method which uses a moving image generated by a mobile phone to configure a WIFI module of a wireless network video camera with audio input function which comprises: A user firstly runs a software application installed in the mobile phone; the software application displays a first image or video on the display screen of the mobile phone; the user positions the display screen of the mobile phone in front of the lens of the video camera; the video camera records the first image or video of the mobile phone automatically and compares the first image or video with a second image or video pre-set in the video camera; and in case the first image or video matches the second image or video, the video camera enters a configuration mode and searches automatically for configuration information being WIFI access points nearby the video camera, and encodes and embeds the configuration information being WIFI access points nearby to a third audio, and then plays the third audio by means of the audio output function of the video camera; the mobile phone receives the third audio played by the video camera which is embedded with the configuration information being WIFI access points nearby and obtains the configuration information being WIFI access points nearby to a third audio by decoding the third audio, and displays the configuration information on the display screen of the mobile phone; the user then selects the desired WIFI access point in the mobile phone and inputs other necessary information such as access password; the software application automatically encodes and embeds the configuration information to a set of configuring images or to the transformation process of a set of configuring images; the mobile phone plays the set of configuring images in a predetermined manner on the display screen thereof; the user positions the display screen of the mobile phone in front of the lens of the video camera; the video camera records the set of configuring images by means of its moving images shooting function and then obtains the configuration information by decoding the set of configuring images and thereafter automatically configures the WIFI module of the video camera. The video camera may send feedback information to the mobile phone and the user through an audio output interface or speaker integrally formed on the video camera; the mobile phone records the feedback information which reflects various status of the video camera during configuration process by means of its audio input interface to understand the status of the video camera, and if necessary in response to the feedback information either informs the user or automatically and dynamically adjusts the configuration information to optimize configuration of the video camera.

### Embodiment 6

A method which uses an audio generated by a mobile phone to configure a WIFI module of a wireless network video camera with audio input function which comprises: A user firstly runs a software application installed in the mobile phone; the software application plays a first audio by the audio output component of the mobile phone, wherein the first audio may be an audio which is encoded according to a specific rule and could only be recognized by the configured video camera, or an audio with specific meaning or pleasing melody which is recognizable by people, such as a music melody, a conversation or even bird whistling sound embedded with configuration information; the video camera records the first audio of the mobile phone automatically and compares the first audio with a second audio pre-set in the video camera; and in case the first audio matches the second audio, the video camera enters a configuration mode and searches automatically for configuration information being WIFI access points nearby the video camera, and encodes and embeds the configuration information being WIFI access points nearby to a third audio, and then plays the third audio by means of the audio output function of the video camera; the mobile phone receives the third audio played by the video camera which is embedded with the configuration information being WIFI access points nearby and obtains the configuration information being WIFI access points nearby to a third audio by decoding the third audio, and displays the configuration information on the display screen of the mobile phone; the user then selects the desired WIFI access point in the mobile phone and inputs other necessary information such as access password; the software application automatically encodes and embeds the configuration information to a configuring audio which may be an audio which is encoded according to a specific rule and could only be recognized by the configured video camera, or an audio with specific meaning or pleasing melody which is recognizable by people, such as a music melody, a conversation or even bird whistling sound embedded with the configuration information; the application software plays the configuring audio by the audio output component of the mobile phone such as its earphone interface, its internal speaker or its audio interface; the video camera records the configuring audio by means of its own audio input function and then obtains the configuration information by decoding the configuring audio and thereafter automatically configures the WIFI module of the video camera. The video camera may by means of its speaker encode and embed to an audio containing feedback information which reflects various status of the video camera during configuration process, and sends the audio containing feedback information to the mobile phone software application and the user through its speaker or audio output interface; the mobile phone software application records the audio containing feedback information by means of its audio input component, and decodes the feedback information to understand the status of the video camera, and if necessary adjusts the configuration information and thereafter sends the adjusted configuration information to the video camera.

1. A method which uses multi-media to configure a configured device being a multi-Media capturing device, characterized in that: the method comprises the following steps:
firstly, running a pre-set program in a configuring device to generate a configuring image, audio or video in the configuring device by means of one of the following:
(1) the pre-set program generating the configuring image or video according to configuration information input from a user; or
(2) the pre-set program detecting configuration information of the configured device and displaying the configuration information in the configuring device, and then automatically encoding and embedding the configuration information to the configuring image or video after selecting and inputting of the configuration information; or
(3) the pre-set program generating a first configuring initiation image, audio or video pre-set in the configuring device; the configured device capturing the first configuring initiation image, audio or video and comparing the first configuring initiation image, audio or video with a second configuring initiation image, audio or video pre-set in the configured device to check if the first configuring initiation image, audio or video matches with the second configuring initiation image, audio or video; and in case the first configuring initiation image, audio or video matches the second configuring initiation image, audio or video, the configured device entering a configuration mode, searching automatically for configuration information of the configured device, encoding and embedding the configuration information to a third image, audio or video and then playing the third image, audio or video; the configuring device obtaining the configuration information encoded and embedded in the third image, audio or video by decoding the third image, audio or video played by the configured device and displaying the configuration information for selection and input by user; the pre-set program automatically encoding and embedding the configuration information to a configuring image, audio or video after the selection and input of the configuration information by the user;
secondly, the pre-set program playing the configuring image, audio or video in the configuring device, followed by the configured device recording the configuring image, audio or video by a shooting module or audio input module thereof, and then the configured device obtaining the configuration information by decoding the configuring image, audio or video and thereafter configuring the configured device according to the configuration information.

2. The method which uses multi-media to configure a configured device being a multi-media capturing device as in claim 1, characterized in that the method further comprises:
the configured device sending visual or audio feedback information which reflects various status of the configured device during configuration process to the configuring device through a monitor, a speaker, an audio output interface or an LED status indicating light;
the configuring device in response to the visual or audio feedback information either informing the user or automatically and dynamically adjusting the configuration information to optimize configuration of the configured device.

3. The method which uses multi-media to configure a configured device being a multi-media capturing device as in claim 1, characterized in that the method further comprises:
the configured device sending visual or audio feedback information which reflects various status of the configured device during configuration process to the configuring device through a monitor, a speaker, an audio output interface or an LED status indicating light;
the configuring device in response to the visual or audio feedback information adjusting the configuration information and thereafter sending the adjusted configuration information to the configured device.

4. The method which uses multi-media to configure a configured device being a multi-media capturing device as in claim 1, characterized in that the configuration information refers to WIFI access point information, Bluetooth access point information, ambient temperature, ambient brightness, volume level, user name and password or other data needed to input to the configured device in order to complete the configuration.

5. The method which uses multi-media to configure a, configured device being a multi-media capturing device as in claim 1, characterized in that the configured device is wireless network video camera, smart phone, tablet PC or any other electronic device with image or audio input function.

6. The method which uses multi-media to configure a configured device being a multi-media capturing device as in claim 1, characterized in that the configuring device is mobile phone, personal digital assistant, tablet PC, notebook computer or desktop computer.
